(19) United States
(12) Patent Application Publication
(10) Pub. No.: US 2006/0108482 A1
(43) Pub. Date: May 25, 2006

(54) Fastener

(76) Inventors: Lutz Konrad, Hungen (DE); Markus Wollner, Hungen (DE)

Correspondence Address: REED SMITH LLP, 3110 FAIRVIEW PARK DRIVE, SUITE 1400, FALLS CHURCH, VA, 22042, US

(21) Appl. No.: 10/541,193

(22) PCT Filed: Oct. 24, 2003
(86) PCT No.: PCT/EP03/11788

§ 371 Date: Jun. 30, 2005

(30) Foreign Application Priority Data
Jan. 7, 2003 (DE) 103 00 447.5

(51) Int. Cl. F16L 3/08

(52) U.S. Cl. 248/74.2

(57) ABSTRACT

The invention relates to a fastener (26) for fixing a wiring material, in particular round cables or tubes to a support, in particular to a wall of a building or the similar. The inventive fastener (26) consists of a clip-like flexibly shapeable plastic fixing body (01) having a clip base (19) provided with a fixing element (08) arranged oppositely to the clip opening (20) in a through bore (07). The longitudinal axis of the fastener extends through said clip opening (20).

The invention relates to a fastener for the fixing of wiring materials, in particular round cables or tubes, to a support, in particular a wall of a building or suchlike. Furthermore, the invention relates to a multiple arrangement of such fasteners as well as a magazine arrangement suitable for the latter.

Fasteners, in particular cable clips or suchlike, are known from the prior art.

DE 41 10 769 A1 discloses a cable clip with a two-part plastic body for the fixing of predominantly flat bodies with different dimensions for extremely flat fastenings. The area of application of this cable clip lies predominantly in electrical installation and telecommunications system design.

DE 100 11 552 A1 discloses a fixing system for the fitting of cables, especially concealed cables. For the fixing of the cable, a cable cross-section is accommodated in a receiving space formed between the cable clip and the wall of the housing.

DE 36 24 993 A1 discloses a fastener for the fixing of wiring material to a wall. Apart from a retaining element, which serves to accommodate the wiring material, the known fastener has a mounting plate for the connection with a webbed-cable nail driver.

A drawback with the known fasteners is the fact that, prior to or at the same time as the fixing to the wall, positioning of the wiring material on the wall must first be carried out, so that the use of the known fasteners is usually time-consuming and correspondingly cost-intensive.

The problem of the present invention is to propose a simply designed fastener, which enables a cost-effective fixing of wiring material to a wall.

This problem is solved by the fastener according to the teaching of claim 1.

The invention concerns a fastener for the fixing of wiring material, in particular round cables or tubes, to a support, in particular a wall of a building or suchlike, whereby the fastener has a clip-like fixing body made from flexibly shapeable plastics material with a clip base, which is provided with a fixing element in a through-bore arranged opposite the clip opening, the direction of the longitudinal axis of said fixing element running through the clip opening.

A fastener thus designed proves to be particularly advantageous, especially in combination with a compressed-air nail driver. The ram of the compressed-air nail driver can act through the clip opening directly on the fixing element. Since no other positioning of the fastener is required beforehand, a straightforward and cost-effective installation of the fastener can take place.

A further advantage lies in the favourable installation sequence when fitting the fasteners. In order to prevent damage to cables or tubes during installation, the wiring material is clipped into the fastener only after installation has been completed, so that positioning and fixing of the wiring material can take place in one work step.

The clipping-in of the wiring material into the fastener makes it possible for the wiring material to be removed at any time from the fastener. Previous unscrewing or removal of the fastener is not therefore required.

The fasteners are used chiefly for the fixing of round cables, for example so-called “NYM cables”, or tubes to brickwork, concrete walls and concrete floors, or in dry construction and on all surfaces which are later plastered. The fasteners can be nailed, according to the planned cable run on the support, with a commercially available compressed-air, battery or electric nail driver, but one adapted to the magazine shape.

For this purpose, the fastener is provided with a fixing element. To advantage, this fixing element is a steel nail, so that no previous holes or threads are required in order to secure the fixing element.

In order to guarantee a reliable seating of the fixing element, the fastener can be held by a press fit in the fastener. This has the advantage that, during installation of the fasteners, the fixing elements cannot fall out of the fastener. This fact proves to be a great advantage especially in the case of overhead work.

If the clip base of the fastener has a recess, in which a head of the fixing element can be accommodated essentially completely, it is possible to prevent the cable being damaged by a head of the fixing element projecting into the inner contour of the fastener.

It is advantageous for there to be provided on the fastener a clip opening, which is formed by free ends of two clip arms connected to the clip base, and for the clip arms to be able to be brought into contact with the outer periphery of the wiring material in a keyed and/or friction-locked manner for the purpose of fixing the wiring material. After it has been clipped into the fastener, therefore, the wiring material is held not only axially in a friction-locked manner, but also radially in a keyed manner.

It is also advantageous for the clip arms to have an inner contour formed in particular in the shape of a segment of a circle and adapted to the diameter of the wiring material to be fixed.

In order to enable simple clipping-in of the wiring material into the fastener, the free ends of the clip arms can be chamfered at least in zones at their side faces assigned to the clip opening.

Furthermore, the invention relates to a multiple arrangement of fasteners, wherein the fasteners are joined together in such a way that the inner contours of adjacent fasteners formed by the clip arms are aligned with one another. This has the advantage that the multiple arrangement can be designed in a relatively space-saving manner. In addition, the individual fasteners have a uniform positioning with respect to the longitudinal axis of the multiple arrangement.

If adjacent fasteners of the multiple arrangement are joined together by means of at least one predetermined breaking web, which extends in the longitudinal direction of the multiple arrangement between outer faces of the fasteners, the multiple arrangement is on the one hand held together in a stable manner, and on the other hand the fasteners can readily be separated during the installation procedure.

In order to keep the production costs of such a multiple arrangement as low as possible, the multiple arrangement can be produced to advantage as a continuous injection-moulded part.

Such a multiple arrangement is preferably used in a magazine arrangement of a compressed-air nail driver designed for the purpose. The multiple arrangement is arranged displaceable in the longitudinal direction of a magazine housing, so that a feed device acting at a feed end of the magazine housing produces a feed motion of the multiple arrangement towards a stop device at the opposite-lying ejection end of the magazine housing. Furthermore, the ejection end is provided with a push-through opening running at right angles to the longitudinal direction.

With the creation of such a multiple arrangement and a magazine arrangement adapted thereto for compressed-air, battery or electric nail drivers or hand tackers, there is made available to the user a complete fixing system, with which he can lay the most commonly used electric cables and tubing for concealed installation in an efficient manner and at a favourable price.

An embodiment of a fastener according to the invention as well as a multiple arrangement is shown in the following drawings and explained in greater detail.

FIG. 1 shows a fixing body of a fastener in cross-section;

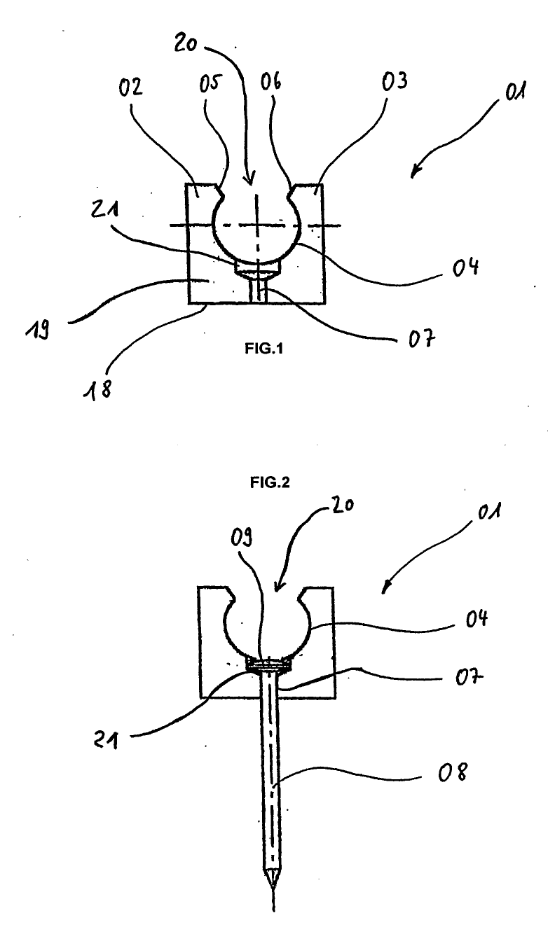

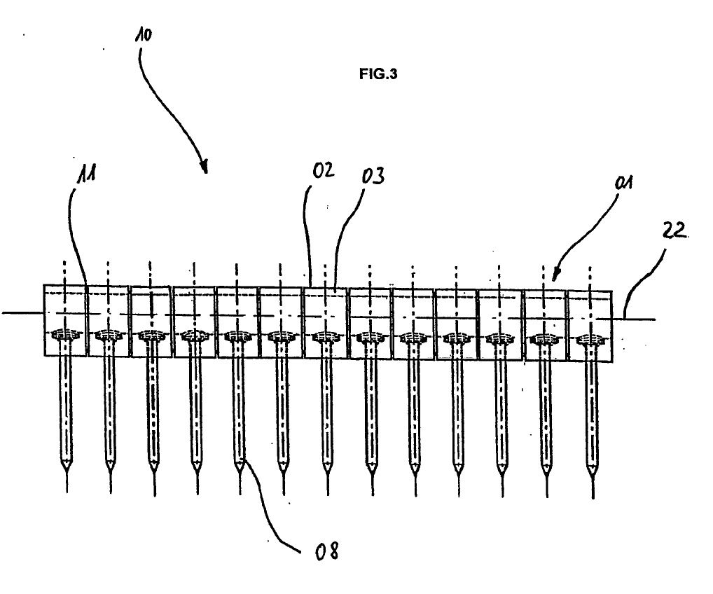

FIG. 2 shows the fixing body according to FIG. 1 with a fixing element;

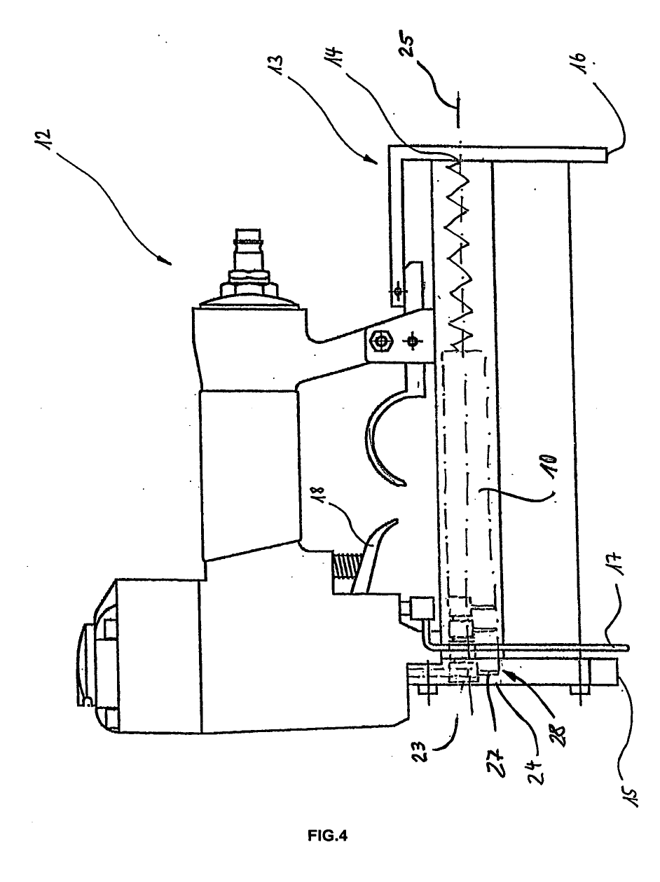

FIG. 3 shows a multiple arrangement formed by several fasteners;

FIG. 4 shows a compressed-air nail driver with a magazine housing fixed thereto.

FIG. 1 shows a clip-shaped fixing body 01 of a fastener 26 in cross-section. A clip base 19 has a bore 07 and a recess 21. A fixing element 08 (FIG. 4) can be seated in bore 07. The head of the fixing element can be essentially completely sunk in recess 21. Furthermore, fixing body 01 has a clip opening 20, which is defined by two free ends of clip arms 02 and 03 connected to clip base 19. Clip opening 20 makes it possible for a ram 27 (FIG. 4) to act in the longitudinal direction of fixing element 08 on a head 09 of fixing element 08 and can thus fix fastener 01 to a support or suchlike. A contact face 18 of fixing body 01 sits against the support.

Clip arms 02 and 03 have an inner contour 04 adapted to the diameter of the wiring material to be fixed. Clip arms 02 and 03 are chamfered in zones at their side faces 05 and 06 assigned to clip opening 20. These chamfers enable easier clipping-in of the wiring material into fastener 01.

FIG. 2 shows, in cross-section, fastener 26 with a fixing element 08 seated in bore 07 of fixing body 01. Fixing element 08 is designed here in the manner of a steel nail. Head 09 of fixing element 08 is sunk essentially completely in recess 21 of fastener 01. This thus guarantees a smooth surface of inner contour 04 in fastener 01. There are therefore no interfering edges or projections of fixing element 08 at inner contour 04, at which the wiring material could be damaged when being clipped in.

FIG. 3 shows a multiple arrangement 10 formed from several fasteners 26. A fixing element 08 is seated in each fixing body 01. Fixing bodies 01 are joined together by means of predetermined breaking webs 11 and are arranged in such a way that inner contours 04 of clip arms 02 and 03 of two fixing bodies 01 adjacent in multiple arrangement 10 are aligned with one another. Multiple arrangement 10 can be formed in a space-saving manner from as many fasteners 01 as possible.

When fasteners 01 are fixed by means of a nail driver, individual fasteners 26 are separated from, in each case, the next fastener 26 by shearing off of predetermined breakage webs 11.

FIG. 4 shows a nail driver 12 with magazine housing 13 fixed thereto for accommodating multiple arrangement 10. Multiple arrangement 10 is introduced via an opening into magazine housing 13. Multiple arrangement 10 is arranged in magazine housing 13 so as to be displaceable in longitudinal direction 25. A feed device 14 formed for example by a pre-load compression spring causes a feed motion of multiple arrangement 10 towards a stop device 23.

In order to release nail driver 12, the latter must be seated with its contact faces 15 and 16 against a support or a wall of a building. A safety mechanism 17, designed here in the manner of push rod, is actuated. Only when the push rod reaches the end position is nail driver 12 unlocked. By operating a lever 18, it is now possible by means of ram 27, which is guided in the interior of a ram channel designed here as a stop device, to separate a fastener 26 from the multiple arrangement 10 by shearing off and to nail-on the same. The fastener is struck and affixed through a push-through opening 28 running at right angles to longitudinal direction 25. Following the shearing-off process, multiple arrangement 10 is automatically pressed by means of feed device 14 against stop device 23. Nail driver 12 is now ready for the next work cycle.

List of reference numbers

1 fixing body
2 clip arm
3 clip arm
4 inner contour
5 side face
6 side face
7 bore
8 fixing element
9 head
10 multiple arrangement
11 predetermined breaking web
12 nail driver
13 magazine housing
14 feed device
15 contact face
16 contact face
17 safety mechanism
18 contact face
19 clip base
20 clip opening
21 recess
22 direction of longitudinal axis
23 stop device
24 ejection end
25 longitudinal direction
26 fastener
27 ram
28 push-through opening

1. A fastener for the fixing of wiring material, in particular round cables or tubes, to a support, in particular a wall of a building or suchlike, characterized in that
the fastener has a clip-like fixing body made from flexibly shapeable plastics material with a clip base, which is provided with a fixing element arranged opposite a clip opening in a through bore, the direction of the longitudinal axis of said fixing element running through the clip opening.

2. The fastener according to claim 1, characterized in that the fixing element is held by a press fit in the fastener.

3. The fastener according to claim 1, characterized in that the clip base has a recess, in which a head of the fixing element can be accommodated essentially completely.

4. The fastener according to claim 1, characterized in that
the clip opening is defined by free ends of two clip arms connected to the clip base, said clip arms being able to be brought into contact with the other periphery of the wiring material in a keyed and/or friction-locked manner for the purpose of fixing the wiring material.

5. The fastener according to claim 4, characterized in that
the clip arms have an inner contour, in particular in the shape of a segment of a circle, adapted to the diameter of the wiring material to be fixed.

6. The fastener according to claim 4, characterized in that
the free ends of the clip arms are chamfered at least in zones at their side faces assigned to the clip opening.

7. A multiple arrangement of a plurality of fasteners for the fixing of wiring material, in particular round cables or tubes, to a support, in particular a wall of a building or suchlike, characterized in that
each fastener has a clip-like fixing body made from flexibly shapeable plastics material with a clip base, which is provided with a fixing element arranged opposite a clip opening in a through bore, the direction of the longitudinal axis of said fixing element running through the clip opening;
the clip opening is defined by free ends of two clip arms connected to the clip base, said clip arms being able to be brought into contact with the other periphery of the wiring material in a keyed and/or friction-locked manner for the purpose of fixing the wiring material;
the clip arms have an inner contour, in particular in the shape of a segment of a circle, adapted to the diameter of the wiring material to be fixed;
the free ends of the clip arms are chamfered at least in zones at their side faces assigned to the clip opening; and
the fasteners are joined together in such a way that inner contours of adjacent fasteners formed by the clip arms are flush with one another.

8. The multiple arrangement according to claim 7, characterized in that
adjacent fasteners are joined together by means of at least one predetermined breaking web, which extends in the longitudinal direction of the multiple arrangement between adjacent outer faces of the fasteners.

9. The multiple arrangement according to claim 8, characterized in that
the multiple arrangement is produced as a continuous injection-moulded part.

10. A magazine arrangement for a multiple arrangement of fasteners, characterized in that
each fastener has a clip-like fixing body made from flexibly shapeable plastics material with a clip base, which is provided with a fixing element arranged opposite a clip opening in a through bore, the direction of the longitudinal axis of said fixing element running through the clip opening; and
the multiple arrangement is arranged so as to be displaceable in the longitudinal direction of a magazine housing, in such a way that a feed device acting at a feed end of the magazine housing produces a feed motion of the multiple arrangement towards a stop device at the opposite-lying ejection end of the magazine housing and the ejection end is provided with a push-through opening running at right angles to the longitudinal direction.

11. The fastener according to claim 2, characterized in that
the clip base has a recess, in which a head of the fixing element can be accommodated essentially completely.

12. The fastener according to claim 2, characterized in that
the clip opening is defined by free ends of two clip arms connected to the clip base, said clip arms being able to be brought into contact with the other periphery of the wiring material in a keyed and/or friction-locked manner for the purpose of fixing the wiring material.

13. The fastener according to claim 3, characterized in that
the clip opening is defined by free ends of two clip arms connected to the clip base, said clip arms being able to be brought into contact with the other periphery of the wiring material in a keyed and/or friction-locked manner for the purpose of fixing the wiring material.

14. The fastener according to claim 11, characterized in that
the clip opening is defined by free ends of two clip arms connected to the clip base, said clip arms being able to be brought into contact with the other periphery of the wiring material in a keyed and/or friction-locked manner for the purpose of fixing the wiring material.

15. The fastener according to claim 12, characterized in that
the clip arms have an inner contour, in particular in the shape of a segment of a circle, adapted to the diameter of the wiring material to be fixed.

16. The fastener according to claim 13, characterized in that
the clip arms have an inner contour, in particular in the shape of a segment of a circle, adapted to the diameter of the wiring material to be fixed.

17. The fastener according to claim 14, characterized in that
the clip arms have an inner contour, in particular in the shape of a segment of a circle, adapted to the diameter of the wiring material to be fixed.

18. The fastener according to claim 12 characterized in that
the free ends of the clip arms are chamfered at least in zones at their side faces assigned to the clip opening.

19. The fastener according to claim 13 characterized in that
the free ends of the clip arms are chamfered at least in zones at their side faces assigned to the clip opening.

20. The fastener according to claim 14 characterized in that
the free ends of the clip arms are chamfered at least in zones at their side faces assigned to the clip opening.

21. The fastener according to claim 5 characterized in that
the free ends of the clip arms are chamfered at least in zones at their side faces assigned to the clip opening.

22. The fastener according to claim 15 characterized in that
the free ends of the clip arms are chamfered at least in zones at their side faces assigned to the clip opening.

23. The fastener according to claim 16 characterized in that
the free ends of the clip arms are chamfered at least in zones at their side faces assigned to the clip opening.

24. The fastener according to claim 17 characterized in that
the free ends of the clip arms are chamfered at least in zones at their side faces assigned to the clip opening.
